(19) United States
(12) Patent Application Publication
(10) Pub. No.: US 2006/0015755 A1
(43) Pub. Date: Jan. 19, 2006

(54) Data collector systems and methods

(75) Inventor: Kenneth Jaffe, Laguna Hills, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Uptake Systems, Inc., Laguna Hills, CA (US)

(21) Appl. No.: 10/892,887

(22) Filed: Jul. 16, 2004

(51) Int. Cl. G06F 12/14

(52) U.S. Cl. 713/193

(57) ABSTRACT

Systems, methods, and machine-readable mediums are provided for collecting data. In one embodiment, a data collector system comprises a data requester interface to receive an information request from a data requester, the information request including a recipient and information collector parameters; an information request creator, communicatively coupled with the data requester interface, to create an create an email having an embedded information collector, the information request creator using the information collector parameters to define the embedded information collector; an email interface, communicatively coupled with the information request creator, to transmit the email to the recipient; and a data collector interface different than the email interface, the data collector interface to receive data associated with the information collector from the recipient.

### BACKGROUND

A wide number of industries collect data for a variety of purposes. For example, data may be collected to provide a service, such as event planning or travel service. As other examples, data may be collected for surveys, such as sales surveys designed to obtain information used to market or sell or product, consumer surveys designed to obtain opinions about a product, or political surveys to obtain data on political opinions.

One technique that may be used to collect data is electronic mail (email). The use of emails may provide low cost data collection with fast response times. Typically, emails used for data collection contain a link to an Internet page. Thus, the data provider (recipient) must access the Internet page to provide the requested information. Alternately, the data provider may provide the information in an email sent back to the data requester. The data requester must then parse the email to obtain the provided information.

### BRIEF SUMMARY

Methods, systems, and machine-readable mediums are disclosed for collecting data. In one embodiment, the system comprises a data requester interface, such as an Internet interface, to receive an information request from a data requester. The information request includes a recipient and information collector parameters. By way of example, the information request may comprise XML data. The system further includes an information request creator, communicatively coupled with the data requester interface, to create an create an email having an embedded information collector. The information request creator uses the received information collector parameters to define the embedded information collector. An email interface is communicatively coupled with the information request creator, and is used to transmit the email to the recipient. The system also includes a data collector interface different than the email interface, which receives data associated with the information collector from the recipient. In this way, the recipient may receive an email with an embedded information collector. The requested information may be input by the recipient without replying to the email. Instead, the recipient simply opens the email, enters the requested information, and selects a submit mechanism embedded within the email.

In some embodiments, the data collector system may further comprise a data store which may be used to store the information request and data received from the recipient. The information collector may convert received data from the received format (e.g., HTML) to a format associated with the data store (e.g., XML). The data collector system may also comprise an information tracker. The information tracker may retrieve data associated with the information request from the data store and use the information to create a report. For example, the report may comprise the received data consolidated with additional data received from one or more additional recipients of the information request. The email interface may be used to transmit the report to the data requester. The information tracker may also be used to receive tracking requests from the data requester to determine a status of the information request and to provide the requested tracking information to the data requester.

In another embodiment, a computerized method for collecting data is disclosed. The method may comprise receiving an information request from a data requester. The information request includes a plurality of recipients and information collector parameters. The information request may also include management information, such as a reply by date, reporting schedule, or reminder schedule. The method further comprises creating an information collector using the information collector parameters. The information collector is operative to collect a response from the recipients. For example, the information collector parameters may include a plurality of possible responses and the information collector may be created by creating a list mechanism, radio button mechanisms, or other type of mechanism for the recipient to select one or more of the possible responses. As another example, the information collector parameters may include one or more column headings and creating the information collector may comprise creating a spreadsheet having the plurality of column headings. After the information collector is created, an email having the information collector embedded within is transmitted to the plurality of recipients. Data associated with the information collector is then received from one or more of the recipients. The data is received at an interface other than an email interface. For example, the recipient may input the requested information directly within the email by using the embedded information collector. The recipient may then submit the information by selecting a submit mechanism that is also embedded within the email. As the data collector receives the information at an interface other than an email interface, the data collector does not have to parse an email to extract the provided information. Additionally, the transmission of the information does not rely on email transmission mechanisms, but is instead uploaded directly to the data collector. In further embodiments, the method may include creating a report consolidating received data associated with the information collector and transmitting the report to the data requester.

In a third embodiment, a method is disclosed which comprises receiving an email having a plurality of embedded information collectors. Data is provided for at least one of the embedded information collectors. The data is transmitted to a data collector using a submission indicator embedded within the email.

### BRIEF DESCRIPTION OF THE DRAWINGS

Illustrative embodiments in accordance with the invention are illustrated in the drawings in which:

FIG. 1 is a block diagram of an exemplary computer network system that may be used in data collection;

FIG. 2 is a block diagram of an exemplary computer system upon which a data collection system may be implemented;

FIG. 3 illustrates an exemplary embodiment of a system that may be used to collect data;

FIG. 4 illustrates exemplary components of a data collector;

FIG. 5 is a flow diagram of a method for collecting data according to one embodiment;

FIG. 6 illustrates an exemplary graphical user interface that may be used by a data requester to define an information request;

FIG. 7 illustrates an exemplary graphical user interface that may be used by a data requester to define parameters for one or more information collectors;

FIG. 8 illustrates a second exemplary graphical user interface that may be used by a data requester to define parameters for one or more information collectors; and

FIG. 9 illustrates an exemplary email with embedded information collectors;

FIG. 10 illustrates an exemplary graphical user interface that may be used by a data requester to track information requests.

### DETAILED DESCRIPTION

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

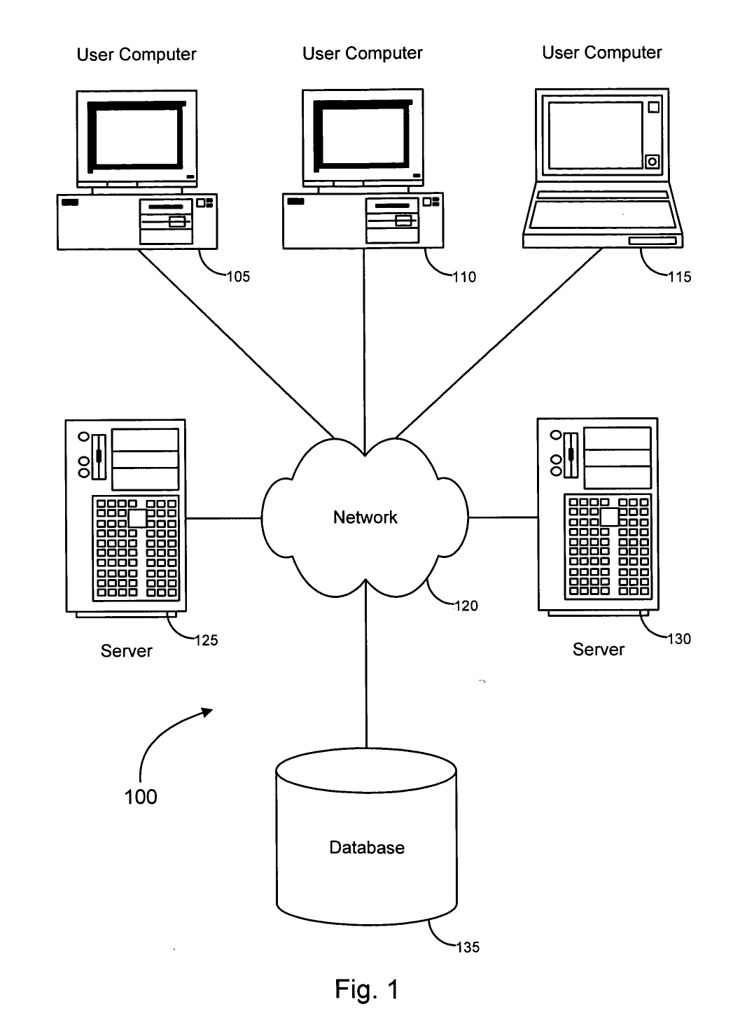

FIG. 1 illustrates a block diagram of a computer network system 100 that may be used to perform data collection. The system 100 includes one or more user computers 105, 110, and 115. The user computers 105, 110, and 115 can be general purpose personal computers (including, merely by way of example, personal computers and/or laptop computers running various versions of Microsoft Corp.'s Windows™ and/or Apple Corp.'s Macintosh™ operating systems) and/or workstation computers running any of a variety of commercially-available UNIX™ or UNIX-like operating systems. These user computers 105, 110, 115 may also have any of a variety of applications, such as web browser applications. Alternatively, the user computers 105, 110, and 115 may be any other electronic device, such as a thin-client computer, Internet-enabled mobile telephone, and/or personal digital assistant, capable of communicating via a network (e.g., the network 120 described below) and/or displaying and navigating web pages or other types of electronic documents. Although the exemplary system 100 is shown with three user computers, any number of user computers may be supported.

System 100 may also include a network 120. The network may be any type of network familiar to those skilled in the art that can support data communications using any of a variety of commercially-available protocols, including without limitation TCP/IP, SNA, IPX, AppleTalk, and the like. Merely by way of example, the network 120 maybe a local area network (“LAN”), such as an Ethernet network, a Token-Ring network and/or the like; a wide-area network; a virtual network, including without limitation a virtual private network (“VPN”); the Internet; an intranet; an extranet; an infra-red network; a wireless network (e.g., a network operating under any of the IEEE 802.11 suite of protocols, the Bluetooth™ protocol known in the art, and/or any other wireless protocol); and/or any combination of these and/or other networks.

The system may also include one or more server computers 125, 130. One server may be a web server 125, which may be used to process requests for web pages or other electronic documents from user computers 105, 110, and 120. The web server can be running an operating system including any of those discussed above, as well as any commercially-available server operating systems. The web server 125 can also run a variety of server applications, including HTTP servers, FTP servers, CGI servers, database servers, Java servers, and the like. In some embodiments, data collection creation and tracking tools may be operated within a web browser on one or more of the user computers 105, 100, 115. In these embodiments, user interactions with a data collector can take place via web pages sent to user computers via the web server 125.

The system 100 may also or alternately include one or more application servers 130, which can, in addition to an operating system, include one or more applications accessible by a client running on one or more of the user computers 105, 110, 115. The server(s) 130 may be one or more general purpose computers capable of executing programs or scripts in response to the user computers 105, 110 and 115. As one example, the server may execute one or more web applications. The web application may be implemented as one or more scripts or programs written in any programming language, such as .NET, Java™, C, C#™ or C++, and/or any scripting language, such as Perl, Python, or TCL, as well as combinations of any programming/scripting languages. The application server(s) 130 may also include database servers, including without limitation those commercially available from Oracle, Microsoft, Sybase™, IBM™, MySQL™ and the like, which can process database requests.

In some embodiments, an application server 130 may create web pages dynamically for displaying data collection information. The web pages created by the web application server 130 may be forwarded to a user computer 105 via a web server 125. Similarly, the web server 125 can receive web page requests and/or input data from a user computer 105 and can forward the web page requests and/or input data to the web application server 130. Although for ease of description, FIG. 1 illustrates a separate web server 125 and application server 130, those skilled in the art will recognize that the functions described with respect to servers 125, 130 may be performed by a single server and/or a plurality of specialized servers, depending on implementation-specific needs and parameters.

The system 100 may also include a database 135. The database 135 may reside in a variety of locations. By way of example, database 135 may reside on a storage medium local to (and/or resident in) on or more of server computers 125, 130. Alternatively, it may be remote from any or all of the computers 105, 110, 115, 125, 130, and in communication (e.g., via the network 120) with server computers 125, 130. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may store information in Extended Markup Language (XML) format. In alternate embodiments, the database 135 may be any other suitable structure for storing data, such as a relational database, that is adapted to store, update, and retrieve data in response to SQL-formatted commands; spreadsheets, text files, internal software lists, or other format.

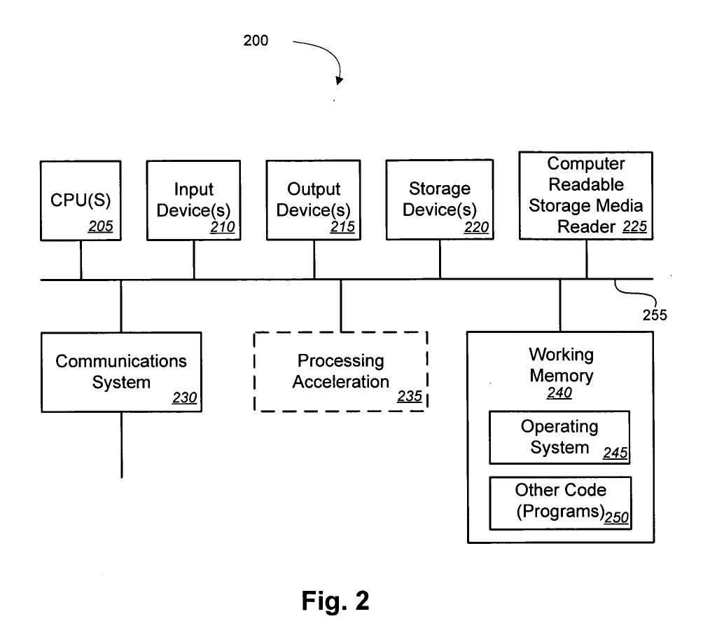

FIG. 2 illustrates one embodiment of a computer system 200 upon which a data collector (or components of a data collector) may be implemented. The computer system 200 is shown comprising hardware elements that may be electrically coupled via a bus 255. The hardware elements may include one or more central processing units (CPUs) 205; one or more input devices 210 (e.g., a mouse, a keyboard, etc.); and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225; a communications system 230 (e.g., a modem, a network card (wireless or wired), an infra-red communication device, etc.); and working memory 240, which may include RAM and ROM devices as described above. In some embodiments, the computer system 200 may also include a processing acceleration unit 235, which can include a DSP, a special-purpose processor and/or the like

The computer-readable storage media reader 225 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with a network and/or any other computer.

The computer system 200 may also comprise software elements, shown as being currently located within a working memory 240, including an operating system 245 and/or other code 250, such as an application program. The application programs may implement an identity provider, components of the identity provider, and/or the methods of the invention. It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed.

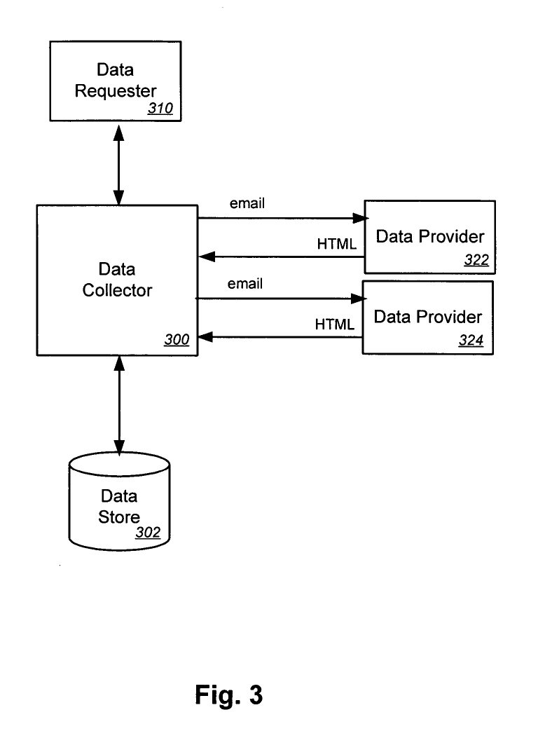

FIG. 3 illustrates an exemplary embodiment of a system that may be used to collect data. The system includes a data collector 300 which may be used to collect data for a data requester 310 from one or more data providers 322, 324. In one embodiment, the data collector 300 may be one or more software programs executing on a computer server. The data requester 310 is communicatively coupled with the data collector 300. By way of example, the data requester 310 may communicate with the data collector 300 via an Internet interface.

As will be described in further detail below, the data requester 310 provides information used by the data collector 300 to create an email having one or more embedded information collectors. The information collectors may be used to obtain data from data providers 322, 324 (also referred to herein as recipients). The data collector 300 sends the created email to the recipients 322, 324. The data providers 322, 324 may then provide data to the data collector 300 using the information collectors. Data associated with an information collector may be transmitted from the data providers 322, 324 to the data collector 300 using a non-email interface, such as a Hyper Text Markup Language (HTML) interface. The data collector 300 may then store the data provided by the data providers 322, 324 in a data store 302 (e.g., Extended Markup Language (XML) data store, relational database, etc.).

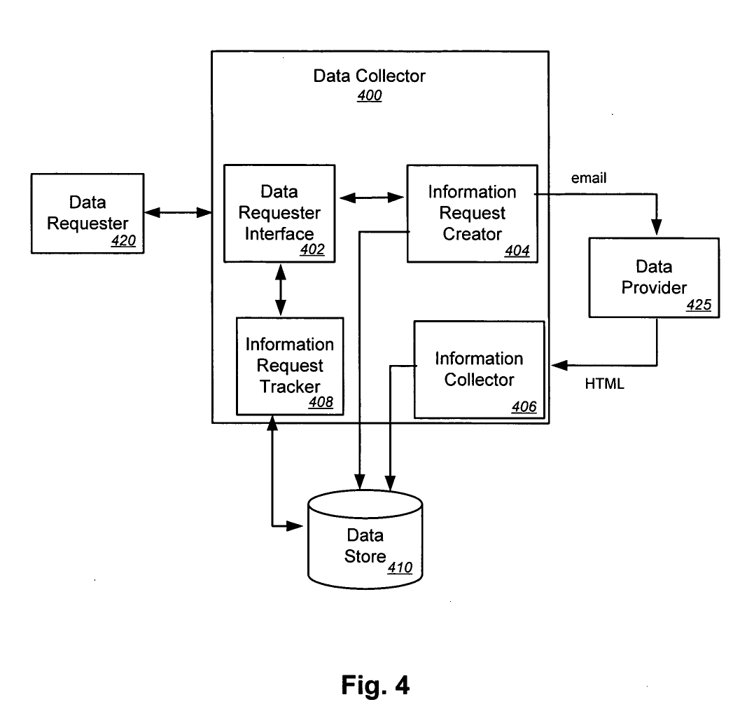

FIG. 4 illustrates exemplary components of a data collector 400. The data collector 400 includes a data requester interface 402, which may be used to receive an information request from a data requester 420. The information request includes recipient information and information collector parameters which may be used by data collector 400 to create one or more information collectors. In one embodiment, the data requester interface 402 may be an Internet interface and the information request may be received from the data requester 420 in a format, such as XML. Optionally, data requester interface 402 may include a graphical user a user interface to assist the data requester in creating the information request.

Data requester interface 402 is communicatively coupled with information request creator 404. An email with information collector(s) embedded within may be created by the information request creator 404. To create the email, the information request creator 404 uses the information collector parameters to define the information collector(s). By way of example, the embedded information collector(s) may be a spreadsheet or HTML form fields, such as list box fields, radio button fields, date fields, or other type of form field that may be used to provide data. The information request creator may then embed the information collectors into an email, such as an HTML email or an email having another appropriate format. In the event the recipient cannot view HTML emails, the embedded information collectors may be made visible in a text email, but an embedded link to an HTML website may need to be used to provide information. In some embodiments, the information request creator 404 may also store details about the information request in a data store 410. The information request details may include the recipient information, the information collector parameters, the information collectors, and/or the email. Additional information that may have been provided by the data requester 420, such as a reply by date, reporting schedule for receiving results, a reminder schedule to send reminders to recipients that did not yet provide data, or other type of information request management information may also be stored in data store 410.

After information request creator 404 has finished creating the email with the embedded information collectors, the email may then be transmitted by information request creator 404 (or another component of data collector 404) to the recipients 425 using an email interface. Data collector 400 may subsequently receive data back from the data provider 425 over a second non-email interface (e.g., an Internet interface). The second interface may be used to receive data associated with the information collector. By way of example, the data may be received in HTML format. In some embodiments, this may be accomplished by embedding within the email a “submit” button or other mechanism that may be used to transmit the data to data collector 400. Thus, advantageously, the recipient is not required to access a web site to provide requested information. Instead, the recipient may be able to simply open the email, enter the requested information directly within the email using an embedded information collector (or in some cases upload a file containing information), and select a submit mechanism which is embedded directly within the email. Additionally, as the information is uploaded directly to data collector 400 over a non-email interface, data collector 400 does not need to parse emails to extract received information. Furthermore, the transmission of the information does not rely on email transmission mechanisms, but may be instead uploaded directly to the data collector 400. This may provide for faster and more reliable transmittal of the information and for a higher degree of data integrity. Additionally, the link may be encrypted to provide greater security.

Data collector 400 further includes an information collector 406 that may be used to received the data provided by data provider 425, using a non-email interface, such as an Internet interface. Information collector 406 may store the received data in data store 410. In some instances, before the data is stored, information collector 406 may convert the data from the received format (e.g., HTML) to a format supported by the data store 410 (e.g., XML or relational database format). Additionally or alternately, information collector 406 may validate the received data for integrity and completeness and/or authenticate the provider of the data was a recipient of the information request before storing it in data store 410.

An information request tracker 408 may also be included in data collector 400. The information request tracker 408 may be used to process the received data by creating and updating reports and/or report statistics summarizing or detailing the received responses. Reports created by information request tracker 408 may also include response rates, lists of recipients not yet providing information, or other tracking or management information for information requests. The reports may be created by information request tracker 408 on a predetermined schedule (such as a default schedule or a schedule determined by data requester 420), after all responses have been received, or upon request. In some embodiments, information request tracker 408 may email the reports to data requester 420 using an email interface. The reports may be provided in a variety of formats, such as XML or a spreadsheet attachment. Alternately or additionally, information request tracker 408 may include a graphical user interface, such as an Internet web page, that may be used by the data requester 420 to view and/or create reports, track the status of a request, or otherwise manage an information request.

In the configuration described above, different components were described as being communicatively coupled to other components. A communicative coupling is a coupling that allows communication between the components. This coupling may be by means of a bus, cable, network, wireless mechanism, program code call (e.g., modular or procedural call) or other mechanism that allows communication between the components. Thus, it should be appreciated that data requester interface 402, information request creator 404, information collector 406, information request tracker 408, and data store 410 may reside on the same or different physical devices. Additionally, it should be appreciated that in alternate embodiments, the system described in FIG. 4 may contain additional or fewer components.

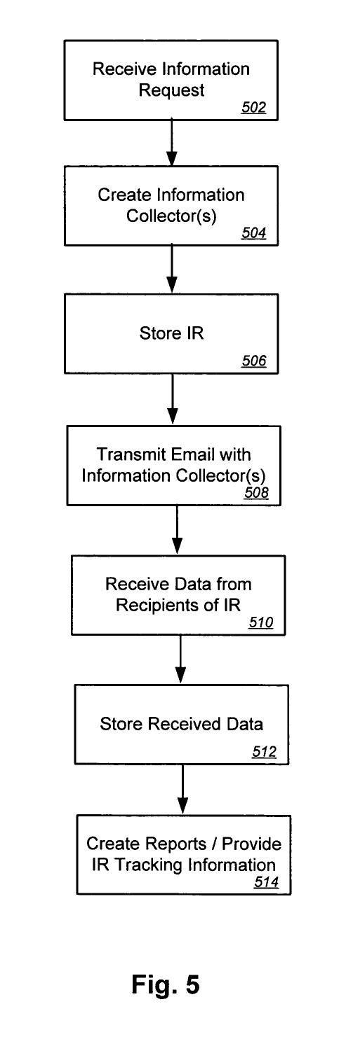

FIG. 5 is a flow diagram illustrating an exemplary method that may be used to collect data. The method may begin by receiving 502 an information request from a data requester. The information request may be received as XML data or in another appropriate format. In one embodiment, the method may further include validating the information request for integrity and completeness. The information request may be received from a data requester who created the data for the information request (e.g. XML data). Alternately, the information request may be received from the data requester via a user interface, such as that described below, which may be provided to assist the data requester in creating an information request.

The information request includes recipient information and information collector parameters which may be used to create embedded information collectors. By way of example information collect parameters may include questions, possible responses to the questions, whether the question is optional or required, display mechanism type for the question/responses (e.g., list box, checkboxes, pull-down lists, radio buttons, text boxes, etc.), spreadsheet column headings, or other type of parameter that may be used to define an embedded information collector. In some embodiments, the information request may also include management information, such as a reply by date for the information request, a reminder schedule to send reminders to recipients that did not yet respond or provide data for the information request, a reporting schedule to provide received data to the data requester, and other types of information that may be used to manage an information request.

The information collector parameters received as part of the information request may be used to create 504 one or more information collectors. Creating 504 the information collector may include translating the information collector parameters from one format to a format that may be used to embed the information collector in an email. By way of example, the information collector parameters may be translated from XML to HTML. In some embodiments, the XML may be received via a Web Service. The information collectors created 504 may be used to collect responses from the recipients. As one example, an information collector may be a list mechanism, such as a list box or drop-down list, from which a data provider may select one or more responses. As another example, an information collector may include one or more radio buttons for a plurality of responses, from which a user may select a response. Another type of information collector may be an information collector which allows a recipient to upload a file, such as a spreadsheet file having column headings defined by information collector parameters. It should be appreciated that a wide variety of other types of information collectors not mentioned may also be used to collect data from a data provider.

After the information request is received 502, it may be stored 506 in a data store. The data store may be any type of structure that may be used for storing information, such as a relational database, text file, spreadsheet, internal software lists, or other data storage structure. In one embodiment, the data store may be an XML database. The information stored 506 in the data store may include the data requester, an information request identifier, recipients of the information request, information request management information, information collector parameters and/or the created information collectors, or other types of information related to the information request.

The method further includes transmitting 508 an email to the plurality of recipients designated in the information request. The information collectors are embedded within the email. Thus, the recipients of the email may use the information collectors to respond directly to questions in the email. In some instances, the recipient may fill out information in an attached file, such as a spreadsheet file, and the information collector may allow the recipient to upload the file with the provided data. After the data has been provided, the recipient may transmit the data via a non-email interface, such as by activating a submit mechanism that uploads the data contained in the information collectors.

Data provided by the recipients using the information collectors is received 510 from the recipients via a non-email interface. By way of example, the data may be received via an internet interface, such as an HTML interface. Optionally, the received data may be validated for data integrity, to ensure that all required information collectors have data, and/or to validate the transmitter of the data is one of the designated recipients. The data may then be stored in the data store. Before the data is stored, it may be converted from the received format (e.g., HTML) to the format associated with the data store (e.g., XML). In some embodiments, after the information is received, the recipient may receive a confirmation email. The data requester may also be notified (e.g., via email) that new data has been received.

Reports and/or information request tracking may be provided 514 to the data requester. For instance, a report may be created consolidating the data received from one or more recipients. The report may then be transmitted (e.g., via email) to the data requester. The report may be provided as specified by a reporting schedule, which may be a default reporting schedule or a schedule provided by the data requester. The report may also be created and transmitted upon request. Other types of reports may also be provided to the data requester. By way of example, reports may include detailed reports listing responses of each data provider, statistics summarizing provided data, lists of recipients responding/not responding, response rate statistics, or other types of reports on received data or information request tracking. Reports may be provided in a variety of formats, such as XML, text files spreadsheets, or other format. Reports or tracking information may also be provided via a user interface, such as a web interface. To create a report or respond to an information tracking request, data associated with the information request may be retrieved from the data store and used to create the report or response to a tracking request.

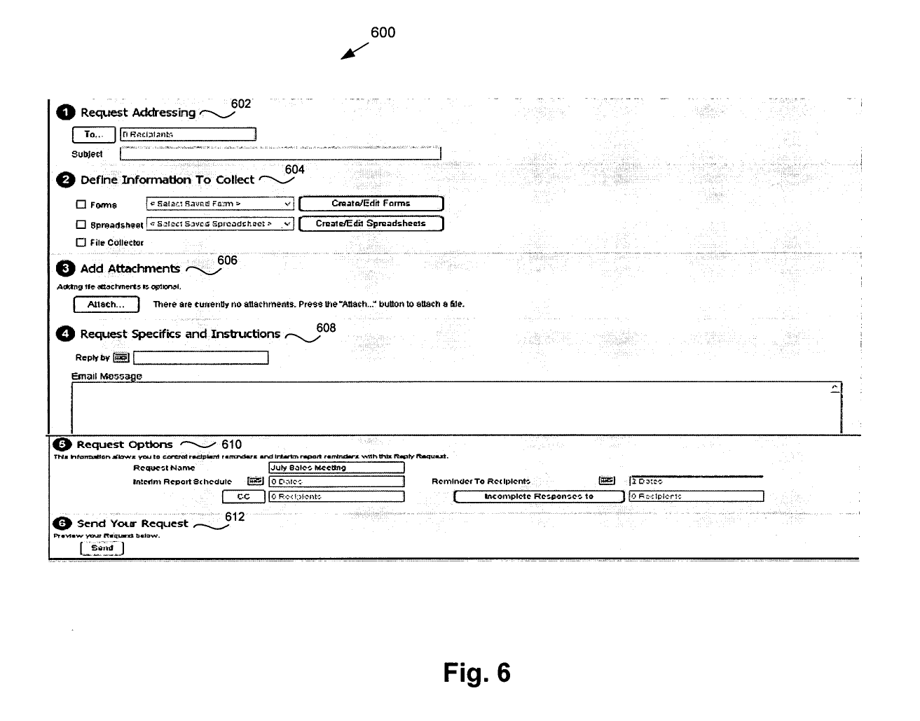

FIGS. 6-8 illustrate exemplary user interfaces that may be provided to assist a data requester in creating an information request. In one embodiment, the user interface may be a web interface to a web service that will create the information request. It should be appreciated that in alternate embodiments, the data requester may manually create an information request or use their own tools to create the information request in the proper format (e.g., XML data). It should also be appreciated that the user interfaces described below are illustrative examples. Numerous variations may be made to the user interfaces described. For example, sections may be added, removed, modified, combined, rearranged, or split into multiple screens.

As shown in FIG. 6, a user interface 600 that may be provided to assist a data requester in creating an information request may include multiple sections 602-612 for the requester to define the request. One section 602 may be used to obtain the recipients of the information request. In some embodiments, recipient information may be entered through a widget that allows cutting and pasting. Additional information, such as the subject line of an email sent to the recipients may also be obtained.

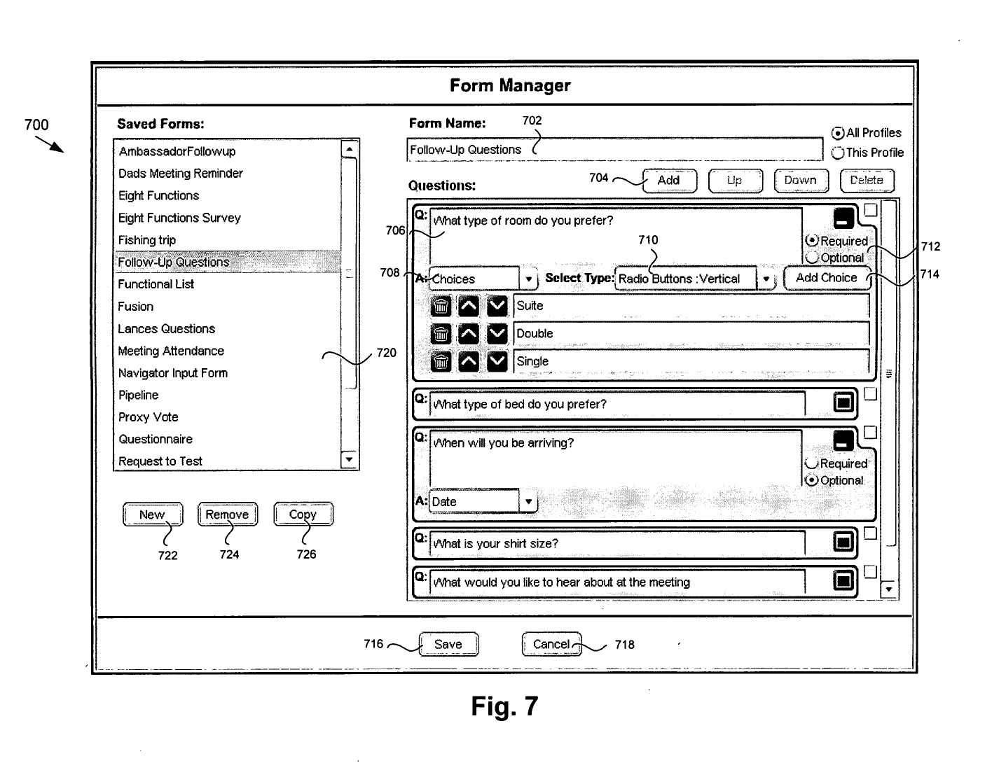

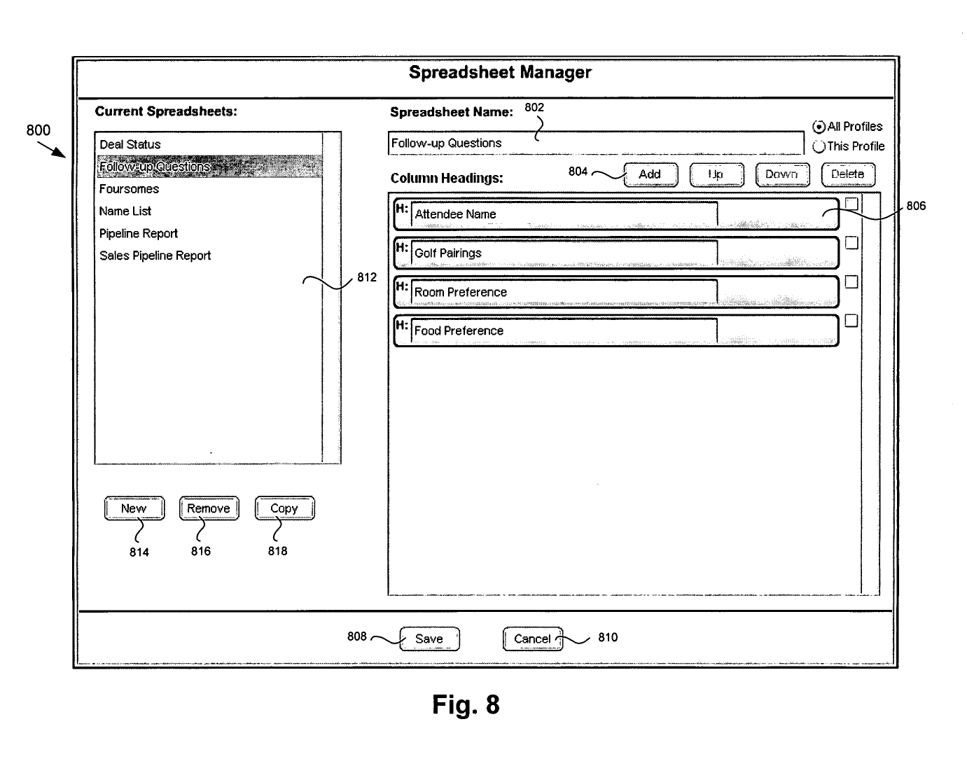

A second section 604 may be used to define information collector parameters, such as form parameters, spreadsheet parameters, or file collector (which defines an information collector which allows the data provider to upload data in a file). Additional user interfaces, as will be described in FIGS. 7 and 8, may be provided to obtain the information collector parameters. In one embodiment, the data requester may access these additional screens by selecting a mechanism, such as a button, to create information collector parameters of a certain type, such as a form or spreadsheet. A third section 606 may be provided to allow the data requester to attach files to the email.

Section 608 may be used to receive information request details and management information from the data requester. For example, this information may include a reply by date and an email message to the recipients. Section 610 may be used to provide further management information, such as a request name, a reporting schedule to provide received data, a reminder schedule to remind recipients that did not yet respond, a carbon copy list for emails to receive results, escalation emails to provide notification that a data provider has not responded (e.g., a data provider's supervisor) or other information request management information. A section 612 may also be provided for the data requester to send and/or preview the information request email.

FIG. 7 illustrates an exemplary user interface 700 that may be used to define information collector parameters for a form. A text-entry boxy 702 may be provided for the form name. A button or other mechanism 704 may be selected to add additional questions to the form. A text entry box 706 may be provided to enter the question for the information request. Another widget 708, such as a drop down list, may be provided for the data requester to select the type of answer to the question (e.g., choices, date, text, etc.). If the answer type is choices, the data requester may be able to select the type of choice to be displayed using another widget 710. For instance, using widget 710 (here a drop-down list), the data requester may be able to select to display the choices as vertical or horizontal radio buttons, drop down list, list box, check boxes, or other format for displaying choices. Choices may be added by selecting a button or other mechanism 714 to add a choice. In section 712, the data requester may specify whether the question is optional or required.

Buttons or other types of widgets may also be provided for the data requester to save 716 or cancel 718 the form. In some embodiments, previously created forms may be reused. Thus, a list of saved forms 720 may be provided for the data requester to select one or more previously created forms. Additionally, buttons or other mechanisms 722, 724, 726 may be provided for the data requester to create a new form 722, to remove 724 a form from the saved forms list, or to copy 726 a form. Other widgets may also be provided to facilitate the reuse of forms.

A second exemplary user interface 800 for assisting a data requester in defining information collector parameters for a spreadsheet is illustrated in FIG. 8. A text-entry boxy 802 may be provided for the spreadsheet name. A button or other mechanism 804 may be selected to add column headings to the spreadsheet. A text-entry box 806 may be provided to enter the column heading name. Buttons or other types of widgets may also be provided for the data requester to save 808 or cancel 810 the spreadsheet. The user interface may also provide for the reuse of spreadsheets by listing previously saved spreadsheets 812 and providing mechanisms (e.g., buttons) to create a new 814 spreadsheet, remove 816 a previously saved spreadsheet, or copy 818 a spreadsheet.

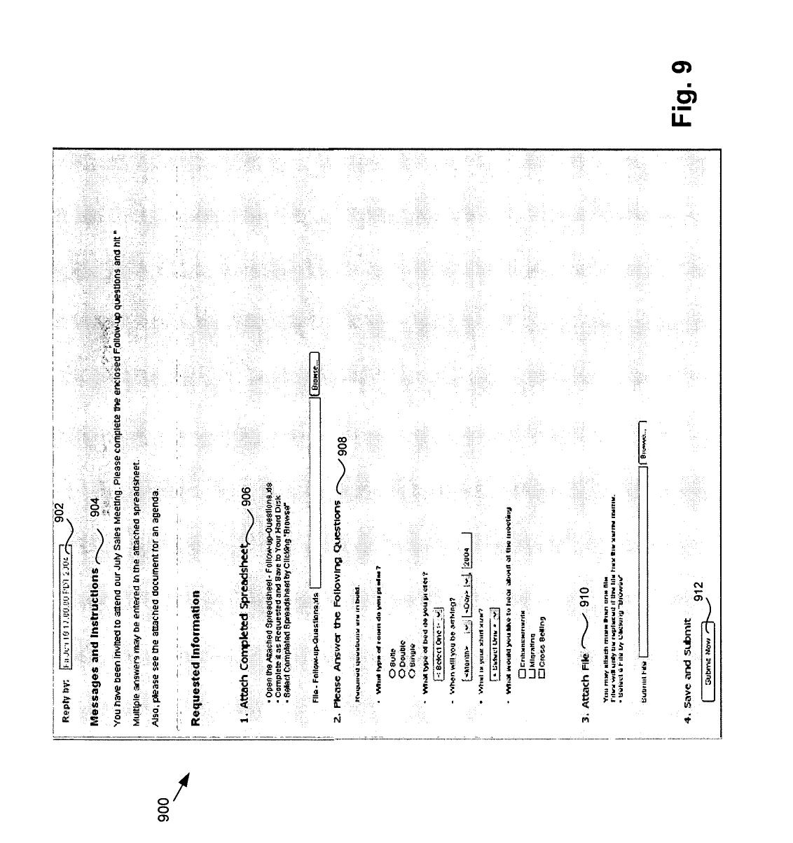

FIG. 9 illustrates exemplary contents of an email 900 with embedded information collectors. The contents of the email may include a reply by date 902, and messages and instructions 904 for the recipient. Another section 906 may contain an embedded information collector which may be used to receive a spreadsheet. Instructions may be provided to the recipient on how to complete data for a spreadsheet which was attached to the email and on how to upload the completed file using the embedded information collector. The email may alternately or additionally include a section 908 that includes one or more embedded information collectors that may be completed directly within the email. For instance, the information collectors may include radio button choices, list box choices, dates, check box choices, text boxes, or other types of information collectors. A third section 910 may be provided for the recipient to attach one or more additional files to be included with their response. Finally, a button or other type of submission indicator 912 is included to allow the recipient to upload the provided data directly to a data collector.

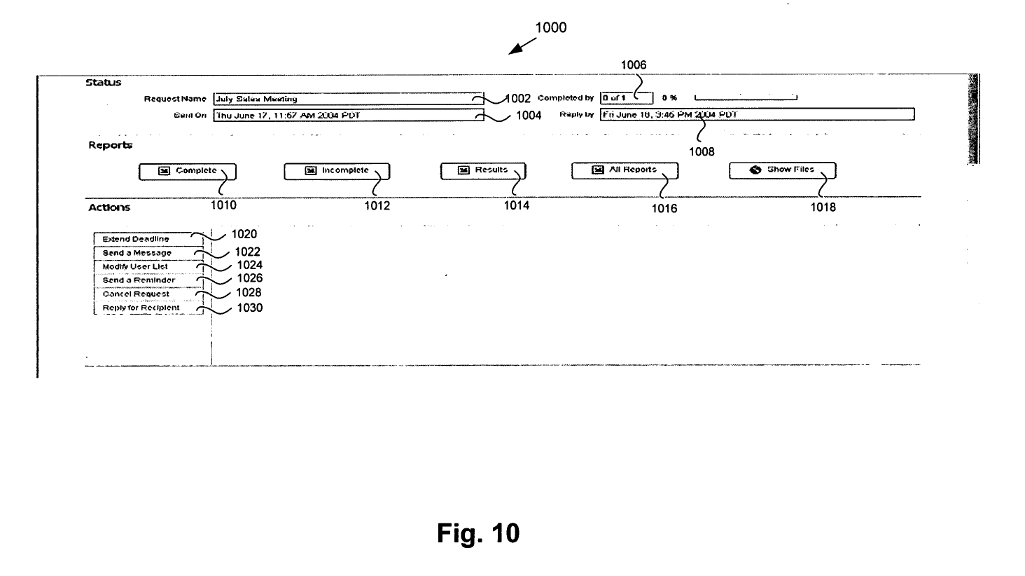

FIG. 10 illustrates an exemplary user interface (e.g., a web interface) 1000 that may be provided to assist a data requester in tracking and managing information requests. The interface may include status information for a specified request name 1002. The status information may include, for example, the date 1004 the information request was sent, the number of responses received 1006, and the targeted reply by date 1008. Buttons or other types of widgets may also be provided for the data requester to view one or more reports on the information request. By way of example, these reports may include a list of recipients that completed 1010 the information request, a list of recipients that did not complete 1012 the information request, a report summarizing or detailing the provided data 1014. Other reports are also contemplated. Another button 1016 may be provided to allow the data requester to view all reports. Button 1018 may allow the data requester to view files received from the recipients.

The user interface 1000 may also allow the data requester to manage the information request. Thus, the user interface 1000 may provide mechanisms that allow the data requester to extend the deadline of the information request 1020, send a message to the recipients 1022, modify the recipient list 1024, send a reminder to the recipients 1026, cancel the information request 1028, and/or submit a reply to the information request for a recipient 1030. Other types of management tasks may also be facilitated by user interface 1000. In alternate embodiments, the user interface may include additional, fewer, or alternate sections and mechanisms than that described above.

The data collection system and methods described above may be used in a variety of applications. For instance, the data collection system may be used to assist a data requester to perform event planning. Emails may be sent with embedded information collectors to obtain lists of attendees, and other event preference information. The information collectors may thus include a spreadsheet for obtaining attendee data, radio button collectors to obtain room preference information, list box collectors to obtain event choices, text box collector to obtain general comments, and/or other types of collectors used to assist in the event planning. As another example, the data collection system may be used by financial service providers or other entities to collect proxy votes. An email with an embedded information collectors having voting choices may be sent to the voters. Other exemplary applications may include collection of data for surveys, collection of medical data, collection of human resources data, collection of sales data, data collection for regulatory compliance, data collection for legal matters, and data collection for mystery shopping. It should be appreciated that a wide variety of applications not mentioned may also use the data collection systems and methods described above.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A data collector system comprising:
a data requester interface to receive an information request from a data requester, the information request including a recipient and information collector parameters;
an information request creator, communicatively coupled with the data requester interface, to create an create an email having an embedded information collector, the information request creator using the information collector parameters to define the embedded information collector;
an email interface, communicatively coupled with the information request creator, to transmit the email to the recipient; and
a data collector interface different than the email interface, the data collector interface to receive data associated with the information collector from the recipient.

2. The data collector system of claim 1, further comprising a data store to store the information request.

3. The data collector system of claim 2, further comprising an information collector, communicatively coupled with the data collector interface, to store the received data in the data store.

4. The data collector system of claim 2, wherein before the information collector stores the received data, the information collector converts the received data from the received format to a second format associated with the data store.

5. The data collector system of claim 2, further comprising an information tracker, communicatively coupled with the data store, to retrieve data associated with the information request from the data store, and to create a report using the retrieved data.

6. The data collector system of claim 5, wherein the report comprises the received data consolidated with additional data received from one or more additional recipients of the information request.

7. The data collector system of claim 5, wherein the email interface is further to transmit the report to the data requester.

8. The data collector system of claim 5, wherein the information tracker is further to receive a tracking request from the data requester to determine a status of the information request, and to provide tracking information to the data requester via the data requester interface.

9. The data collector system of claim 1, wherein the data requester interface is an Internet interface and the information request comprises XML data.

10. The data collector system of claim 9, wherein the information request creator uses the XML data to create the email in HTML format.

11. The data collector system of claim 1, wherein the data collector interface is an Internet interface.

12. The data collector system of claim 11, wherein the Internet interface is an HTML interface.

13. A computerized method for collecting data comprising:
receiving, from a data requester, an information request, the information request including a plurality of recipients and information collector parameters;
creating an information collector using the information collector parameters, the information collector operative to collect a response from the recipients;
transmitting an email to the plurality of recipients, the email including the information collector embedded within the email; and
receiving, at an interface other than an email interface, data associated with the information collector from one or more of the recipients.

14. The method of claim 13, further comprising:
creating a report consolidating received data associated with the information collector;
transmitting the report to the data requester.

15. The method of claim 13, wherein receiving the information request comprises receiving XML data including the recipients and the information collector parameters.

16. The method of claim 15, wherein creating the information collector comprises translating the XML data to HTML.

17. The method of claim 15, further comprising validating the XML data.

18. The method of claim 13, wherein the information collector parameters include a plurality of possible responses and wherein creating the information collector comprises creating a list mechanism that may be used by the recipient to select one of the possible responses.

19. The method of claim 13, wherein the information collector parameters include a plurality of possible responses and wherein creating the information collector comprises creating a radio button for each of the possible responses.

20. The method of claim 13, wherein the information collector parameters include one or more column headings and wherein creating the information collector comprises creating a spreadsheet having the plurality of column headings.

21. The method of claim 13, further comprising sending a reminder to a non-responsive recipient that did not respond to the information request.

22. The method of claim 13, further comprising:
converting the data to a format associated with a data store; and
storing the data in the data store.

23. The method of claim 22, wherein converting the response comprises converting the data from an HTML format to an XML format.

24. The method of claim 13, further comprising, storing the information request in a data store.

25. The method of claim 24, further comprising:
receiving a tracking request from the data requester to track a status of the information request;
retrieving data associated with the information request from the data store; and
providing tracking information to the data requester based on the retrieved data.

26. The method of claim 25, wherein providing tracking information includes providing information indicating one or more of the recipients that did not provide data for the information request.

27. The method of claim 13, wherein the information request further includes management information.

28. The method of claim 27, wherein the management information includes a reply by date for the information request.

29. The method of claim 27, wherein the management information includes a reporting schedule to provide collected data to the data requester.

30. The method of claim 27, wherein the management information includes a reminder schedule to send a reminder to recipients that did not provide data for the information request.

31. The method of claim 13, wherein the interface is an Internet interface.

32. The method of claim 31, wherein the Internet interface is an HTML interface.

33. A method comprising
receiving an email having a plurality of embedded information collectors;
providing data for at least one of the embedded information collectors; and
transmitting the data to a data collector using a submission indicator embedded within the email.

34. A machine-readable medium, having stored thereon a plurality of instructions, which, when executed by the machine, cause the machine to:
receive, from a data requester, an information request, the information request including a plurality of recipients and information collector parameters;
create an information collector using the information collector parameters, the information collector operative to collect a response from the recipients;
transmit an email to the plurality of recipients, the email including the information collector embedded within the email; and
receive, at an interface other than an email interface, data associated with the information collector from one or more of the recipients.
